(19) United States
(12) Patent Application Publication
(10) Pub. No.: US 2014/0150043 A1
(43) Pub. Date: May 29, 2014

(54) SCENE FRAGMENT TRANSMITTING SYSTEM, SCENE FRAGMENT TRANSMITTING METHOD AND RECORDING MEDIUM

(71) Applicant: INSTITUTE FOR INFORMATION INDUSTRY, Taipei City (TW)

(72) Inventors: Pei-Wen HUANG, Taipei City (TW); Emery JOU, Taipei City (TW); Chia-Hsiang CHANG, Taipei City (TW)

(73) Assignee: INSTITUTE FOR INFORMATION INDUSTRY, Taipei City (TW)

(21) Appl. No.: 13/714,207

(22) Filed: Dec. 13, 2012

(30) Foreign Application Priority Data
Nov. 23, 2012 (TW) 101143914

(51) Int. Cl. H04N 21/63

(52) U.S. Cl. CPC H04N 21/63
USPC 725/116

(57) ABSTRACT

A scene fragment transmitting system, a scene fragment transmitting method and a non-transitory recording medium thereof are provided. This system includes a serving module and a terminal module. The terminal module is used for inputting a scene instruction. The serving module, according to comparison between the scene instruction and the scene description data, captures one or more than one required scene fragment medium from a piece of media data. The terminal module obtains this scene fragment medium or these scene fragment media, and presents a playable scene fragment medium on a play interface.

### CROSS-REFERENCE TO RELATED APPLICATION

This application claims the benefit of Taiwan Patent Application No. 101143914, filed on Nov. 23, 2012, which is hereby incorporated by reference for all purposes as if fully set forth herein.

### BACKGROUND OF THE INVENTION

1. Field of Invention

The present invention relates to a medium transmitting system and a medium transmitting method, and particularly to a scene fragment transmitting system, a scene fragment transmitting method, and a non-transitory recording medium thereof, in which a required scene fragment medium is transmitted through comparison between play scenes of media data.

2. Related Art

In the prior art, media data is played on line mainly in a linear play manner. A serving device transmits a piece of media data wholly to a client no matter whether the media data is an entire medium file or video/audio streaming. Furthermore, an image play interface mainly provides a timeline for playing media data correspondingly, and a user may click a position on the timeline, or drag a slider on the timeline, so as to determine an image play fragment. After the user completes slider dragging, the serving device, according to a time point corresponding to the slider, provides media data corresponding to this time point to a terminal apparatus to perform a play behavior.

However, if the user is unfamiliar with the played content and the play time point of the media data, the user needs to spend much time in seeking a required video scene. Secondly, the accuracy of the slider dragging depends on the length of the timeline, and if the timeline is excessively short, it is uneasy for the user to drag the slider to a required fixed point. Moreover, if the user intends to obtain a targeted image or voice from the media data, the user usually needs to perform a timeline control operation manually, and it is difficult to immediately find a relevant video scene.

### SUMMARY OF THE INVENTION

To solve the foregoing problem, the present invention discloses a scene fragment transmitting system, a scene fragment transmitting method and a non-transitory, recording medium thereof, in which a medium is captured on the basis of scene contents, and a required scene fragment is captured and transmitted to a terminal.

The scene fragment transmitting system disclosed in the present invention comprises a serving module and a terminal module connected to the serving module. The serving module comprises a storage module and a medium capturing module. The storage module is used for storing media data and scene description data corresponding thereto. The medium capturing module, according to comparison between a scene instruction and the scene description data, captures a scene fragment medium from the media data and outputs the scene fragment medium. The terminal module is used for outputting the scene instruction, and is used for receiving the scene fragment medium, and playing the scene fragment medium. However, the terminal apparatus for inputting the scene instruction, and the terminal apparatus for receiving and playing the scene fragment medium may be the same apparatus or different apparatuses.

The scene fragment transmitting method disclosed in the present invention comprises: outputting, by a terminal module, a scene instruction; capturing, by a serving module according to comparison between the scene instruction and a piece of scene description data, a scene fragment medium from media data; and, outputting, by the serving module, the scene fragment medium to the terminal module, so that the terminal module presents the playable scene fragment medium.

The present invention also discloses a non-transitory recording medium, which stores a program code readable by an electronic apparatus. When reading the program code, the electronic apparatus executes a scene fragment transmitting method. This method is as described above.

In the present invention, by capturing the targeted scene fragment, the user does not need to spend much time in seeking a required video scene. Secondly, by capturing the targeted scene fragment, manipulation of the user on media data is not limited to the length of the timeline, so as to improve the accuracy of the obtained required media data, and avoid the operative disturbance that the user drags the slider to a required fixed point uneasily. Thirdly, by capturing the targeted scene fragment, the user obtains the required scene fragment once for all, so as to form a self-made medium, thereby not only forming customized medium manipulation conforming to user requirements, but also reducing complexity of user operations. Fourthly, no matter whether the media data is transmitted to a terminal of the user side in a data download or video/audio streaming manner, the serving end may, according to comparison between the scene instruction and the scene description data, capture a necessary scene fragment, thereby being capable of reducing the data transmitting amount and reducing the network transmitting load, and the user can also watch a really desirable scene fragment, thereby being capable of promoting the system applicability.

### BRIEF DESCRIPTION OF THE DRAWINGS

The present invention will become more fully understood from the detailed description given herein below for illustration only, and thus are not limitative of the present invention, and in which:

FIG. 1 shows a schematic architectural diagram of a scene fragment transmitting system of an embodiment of the present invention;

FIG. 2 shows a flowchart of a scene fragment transmitting method of an embodiment of the present invention;

FIG. 3 shows a level diagram of a first medium play hierarchical structure of an embodiment of the present invention; and

FIG. 4 shows a level diagram of a second medium play hierarchical structure of an embodiment of the present invention.

### DETAILED DESCRIPTION OF THE INVENTION

Preferable embodiments of the present invention are illustrated in detail below with reference to drawings.

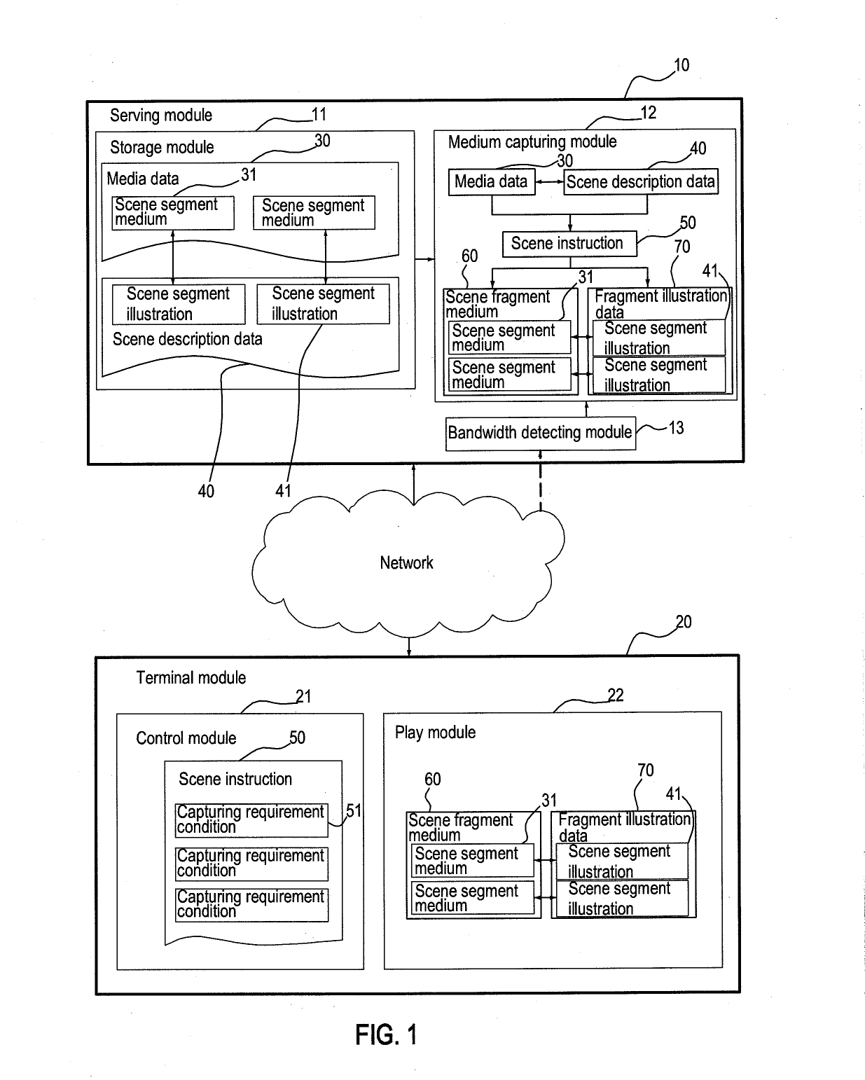

Firstly, FIG. 1 shows a schematic architectural diagram of a scene fragment transmitting system of an embodiment of the present invention. This system is applied to any combination of an apparatus, device or system having a data transmitting capability, and the configuration pattern is not limited. This scene fragment transmitting system includes a serving module 10 and a terminal module 20. The serving module 10 includes a storage module 11 and a medium capturing module 12. The terminal module 20 includes a control module 21 and a play module 22. However, the control module 21 and the play module 22 may also be configured on different terminal modules, and the present invention is not limited thereto.

The serving module 10 and the terminal module 20 both refer to hardware having data transmitting and receiving capabilities, or a combination of more than at least one of a unit, component, apparatus, device and system where software and hardware are combined. The serving module 10 and the terminal module 20 are connected to each other, and a network connection manner is taken as an example herein.

The storage module 11 stores more than one piece of media data 30, each piece of the media data 30 is corresponding to a piece of scene description data 40. The media data 30 is formed of a plurality of scene segment media 31.

The media data 30 includes a plurality of scene segment media 31 with different contents. If the media data 30 is image data, the image data is an image segment having more than one of contents such as a subject, a scene, and a character. Also, if the media data 30 is voice data, the voice data is a voice segment having more than one of contents such as high pitch, low pitch, speeches and music. Alternatively, if the media data 30 is a combination of image data and voice data, the scene segment media 31 includes images and voices simultaneously.

The scene description data 40 is annotation data used for interpreting the media data 30, or further interpreting the scene segment media 31 included in the media data 30, which is for example commentary data such as overview, play time, and title of a played content of the media data 30.

The control module 21 includes a data input interface where a user inputs data, and presentation of this interface depends on requirements of a designer, and is not limited. The user inputs a scene instruction 50 through the control module 21.

The scene instruction 50 includes a capturing requirement condition 51 input by the user when the user intends to capture a particular scene fragment from the media data 30. For example, when the media data 30 is a recorded image of a basketball match, the user inputs the capturing requirement condition 51 such as a scoring picture of a favorite player thereof, or three-point line shooting and scoring pictures of all players of this match, or three-point line shooting and scoring pictures of the favorite player thereof.

The medium capturing module 12 is formed of software, hardware or software and hardware, such as an application soft executed by an operational processor, a chip, an integrated circuit (IC), or further firmware or embedded system in cooperation with the operation of a chip or IC, is not limited, and depends on requirements of the designer.

The medium capturing module 12 obtains the scene instruction 50 from the terminal module 20, and compares the scene instruction 50 and the scene description data 40. The medium capturing module 12 compares the capturing requirement condition 51 of the scene instruction 50 and each piece of the scene description data 40, so as to capture a scene fragment medium 60 conforming to requirements of the scene instruction 50 from the media data 30, or further extracts fragment illustration data 70 from the scene description data 40. This fragment illustration data 70 is description data of a played content of the scene fragment medium 60. The obtaining manner of the scene fragment medium 60 is illustrated below with an example to which the present invention is not limited:

(1) The scene description data 40 records a plurality of pieces of scene play time corresponding to the media data 30 including scenes. The capturing requirement condition 51 of the scene instruction 50 includes at least one required scene play time point. The medium capturing module 12 matches these required scene play time points and the scene play time, so as to obtain the scene segment media 31 conforming to a required scene play time point from the media data 30, and form the scene fragment medium 60. Alternatively, further, scene segment illustrations 41 corresponding to the scene segment media 31 are captured from the scene description data 40, so as to make the scene segment media 31 and the scene segment illustrations 41 form the scene fragment medium 60 and the fragment illustration data 70.

(2) The scene description data 40 records a plurality of scene description illustrations corresponding to the media data 30 including scenes and play time corresponding to each scene description illustration. The capturing requirement condition 51 of the scene instruction 50 includes more than one piece of required scene data. The required scene data refers to an illustration of a scene required by the user. The medium capturing module 12 matches the required scene data and the scene description illustrations, and finds play time of a required scene, thereby capturing the scene fragment medium 60 matching target play time (or the scene segment media 31 is captured to form the scene fragment medium 60) from the media data 30. Alternatively, further, the fragment illustration data 70 matching the target play time is captured (or the scene segment illustrations 41 is captured to form the fragment illustration data 70) from the scene description data 40.

However, the capturing requirement condition 51 included in the scene instruction 50 is not limited to the foregoing two types, and may also include various different capturing requirement conditions 51. The medium capturing module 12 captures a plurality of scene segment media 31 from the media data 30 according to each capturing requirement condition 51.

Moreover, the medium capturing module 12 may divide the media data 30 into a plurality of scene segment media 31 according to the scene description data 40, and construct each of the scene segment media 31 into a medium play hierarchical structure according to a medium dependence relationship between the scene segment media 31, image and sound attributes of a medium, and a level relationship formed when media forms a hierarchical structure.

Alternatively, the medium capturing module 12 may divide the media data 30 into a plurality of scene segment media 31 according to the scene description data 40, and obtain a scene segment illustration 41 corresponding to each of the scene segment media 31 from the scene description data 40 through division, and construct the scene segment media 31 corresponding to the scene segment illustrations 41 into a medium play hierarchical structure according to a medium dependence relationship between the scene segment illustrations 41, image and sound attributes of a medium, and a level relationship formed when media form a hierarchical structure.

However, the interface of the control module 21 may also present an input field of the medium play hierarchical structure model. The user may input each of the capturing requirement conditions 51 into each field, so that the medium capturing module 12 is used as a basis for capturing the scene fragment medium 60 and the fragment illustration data 70 (or the scene segment media 31 and the scene segment illustrations 41).

Moreover, the storage module 11 may also provide a plurality of pieces of media data 30, and provide scene description data 40 corresponding to each piece of the media data 30. The user, at the time of utilizing the control module 21 to input the scene instruction 50, may set different capturing requirement conditions 51 for each piece of the media data 30, or set a capturing requirement condition 51 for all the media data 30, which depends on requirements of the user. The medium capturing module 12 compares relevant scene description data 40 according to the scene instruction 50, so as to find the scene fragment medium 60 and the fragment illustration data 70 conforming to requirements.

The serving module 10 transmits the scene fragment medium 60 and the fragment illustration data 70 to the terminal module 20 at the user side. The play module 22 presents a played content of the scene fragment medium 60 according to the fragment illustration data 70 through a play interface, so as to be selected and watched by the user. The user may utilize the control module 21 to input a scene play command, and the play module 22 plays a scene fragment selected by the user.

Even further, capture results such as the scene segment media 31, the scene fragment medium 60, and the medium play hierarchical structure are stored by the medium capturing module 12 in the storage module 11, so as to be used by the medium capturing module 12 at the time of performing a next capturing operation. Alternatively, the capture results are stored in a memory element of the terminal module 20. Even further, a play medium constructed through a medium capturing operation may be directly used and played by the play module 22 of the system.

Moreover, the scene fragment transmitting system may be further configured with a bandwidth detecting module 13, which is configured at the serving module 10. This bandwidth detecting module 13 is used for detecting the congestion extent of a transmission line (or network path) between the serving module 10 and the terminal module 20, so as to obtain available bandwidth through which the serving module 10 transmits data to the terminal module 20. The medium capturing module 12 adjusts a mode of capturing the scene fragment medium 60 according to this available bandwidth. Adjusted contents include: adjusting a medium capturing frequency of the scene fragment medium 60, adjusting a medium capturing resolution of the scene fragment medium 60, adjusting a medium capturing color depth of the scene fragment medium 60, adjusting a medium capturing gray-scale depth of the scene fragment medium 60, and adjusting a sound capturing frequency of the scene fragment medium 60.

For example, when the transmission path between the serving module 10 and the terminal module 20 is smooth, the medium capturing module 12 may adjust the foregoing capturing mode, so as to extract a scene fragment medium 60 with good quality and transmit it to the terminal module 20. On the contrary, when the transmission path between the serving module 10 and the terminal module 20 is congested, the medium capturing module 12 may, according to the foregoing various capturing technologies, extract a scene fragment medium 60 with bad quality and transmit it to the terminal module 20. The serving module 10 transmits a scene fragment medium 60 with appropriate quality to the terminal module 20 according to the magnitude of the bandwidth, thereby maintaining the stability at which the serving module 10 transmits a film to the terminal module 20.

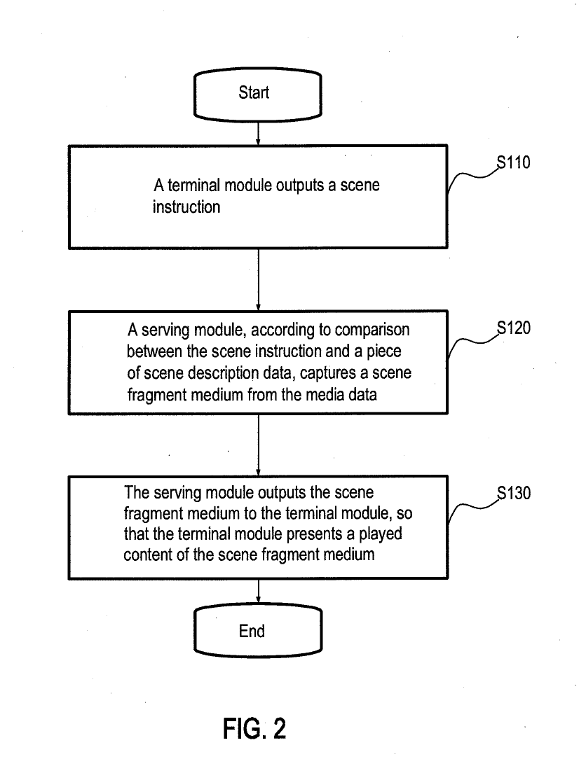

FIG. 2 shows a flowchart of a scene fragment transmitting method of an embodiment of the present invention, which is better understood with reference to FIG. 1. The process of this method is as follows:

A terminal module 20 outputs a scene instruction 50 (step S110). As described above, the user may utilize the control module 21 to input the scene instruction 50, which includes a capturing requirement condition 51 of a required scene segment. The terminal module 20 outputs the scene instruction 50 to an upstream serving party.

A serving module 10, according to comparison between the scene instruction 50 and a piece of scene description data 40, captures a scene fragment medium 60 from the media data 30 (step S120). After the serving module 10 obtains the scene instruction 50, the medium capturing module 12 compares the media data 30 and the scene description data 40, so as to intend to find a scene fragment medium 60 conforming to requirements of the scene instruction 50. Further, the fragment illustration data 70 for illustrating the scene fragment medium 60 is obtained. The comparison method is mentioned above, and is not described anymore herein.

The serving module 10 outputs the scene fragment medium 60 to the terminal module 20, so that the terminal module 20 presents a played content of the scene fragment medium 60 (step S130). After the terminal module 20 obtains the scene fragment medium 60 (or further obtaining the fragment illustration data 70), the play module 22 presents the played content of the scene fragment medium 60 through a play interface, so as to be selected and watched by the user. Alternatively, the played content of the scene fragment medium 60 is presented in cooperation with the fragment illustration data 70. The user may utilize the control module 21 to input a scene play command, and the play module 22 plays a scene fragment selected by the user.

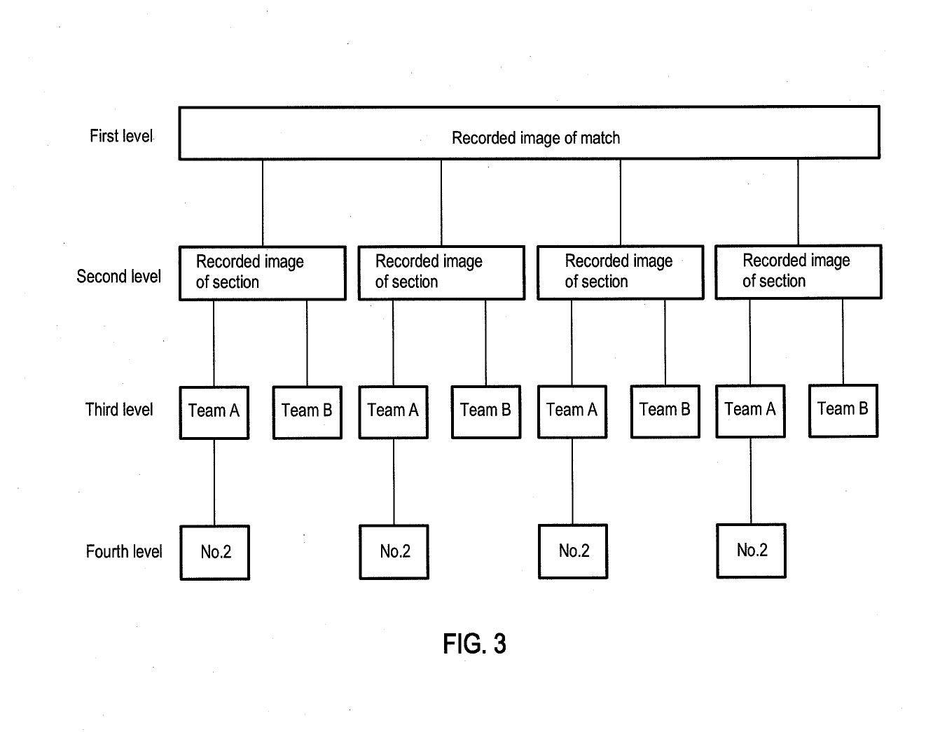

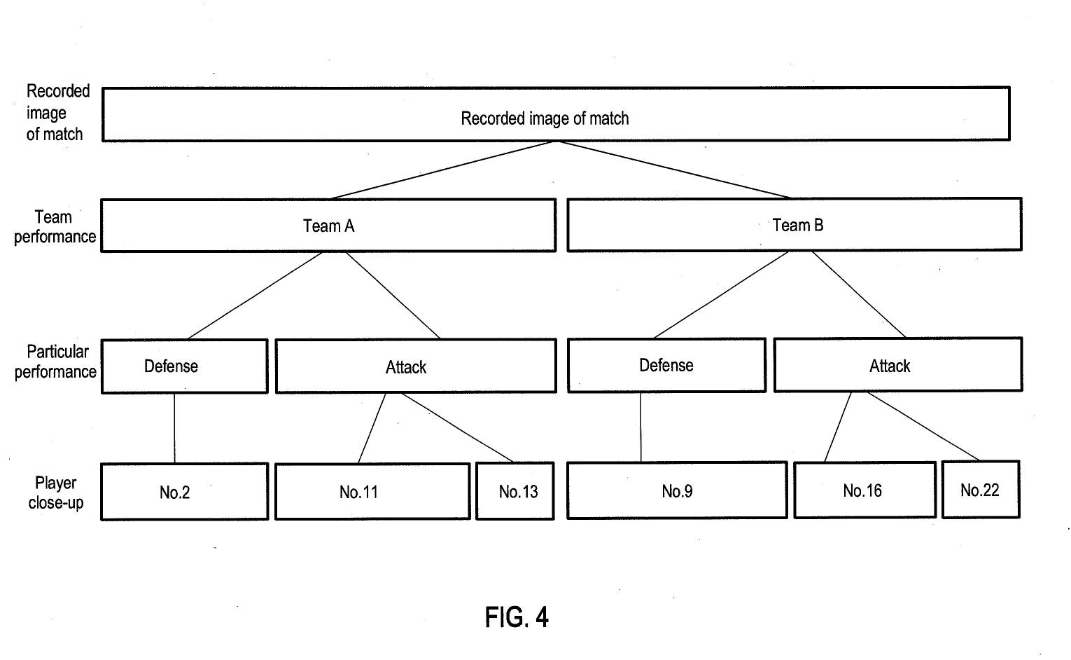

FIG. 3 to FIG. 4 show schematic level diagrams of two medium play hierarchical structures of an embodiment of the present invention. Here, media data 30 is illustrated by taking a recorded image of a basketball match as an example.

FIG. 3 shows a schematic level diagram of a first medium play hierarchical structure of an embodiment of the present invention. A recorded image of a basketball match may be divided into different image level. A recorded image of the entire match is at the highest level; a recorded image of each section is at the second highest level; a recorded image of a close-up scene is at the third highest level. The entire recorded images are formed of many scene segment media 31, and are corresponding to the scene segment illustrations 41. However, each level may be regarded as a basis of a medium division mode. The medium division mode includes manners of dividing the time length and the scene played content type of the media data 30.

After the user sets the scene instruction 50, the medium capturing module 12, according to a requirement condition included in the scene instruction 50, captures the required scene segment media 31 from the media data 30 through a medium play hierarchical structure, so as to form the scene fragment medium 60, and captures the required scene segment illustrations 41 from the scene description data 40, so as to form the fragment illustration data 70.

However, the scene segment media 31 captured by the medium capturing module 12 are not required to give consideration to the foregoing image level. For example, when the user intends to watch “all scoring pictures of player No. 2 of team A”, and then watches “the entire recorded images of the fourth section”, the medium capturing module 12, extracts the scene segment media 31 and the scene segment illustrations 41 corresponding to “team A No. 2 player all scoring picture” according to a fourth level structure of the medium play hierarchical structure, and extracts the scene segment media 31 and the scene segment illustrations 41 corresponding to “the entire recorded images of the fourth section” according to a second level structure of the medium play hierarchical structure, so as to form the scene fragment medium 60 and the fragment illustration data 70 according to the aforementioned medium capturing manner.

That is, the medium capturing module 12 may capture the scene segment media 31 and the scene segment illustrations 41 corresponding to the same level, different levels or locally the same level and locally different levels from a medium play hierarchical structure, and integrate the scene segment media 31 and the scene segment illustrations 41 into the scene fragment medium 60 and the fragment illustration data 70, so as to transmit the scene fragment medium 60 and the fragment illustration data 70 to the terminal module 20.

FIG. 4 shows a schematic level diagram of a second medium play hierarchical structure of an embodiment of the present invention. This medium play hierarchical structure is basically similar to the medium play hierarchical structure shown in FIG. 3, but the difference lies in that, image level meanings of levels are different. That is to say, a user or media data manager, according to his/her hobby, may construct medium play hierarchical structures in different aspects for the same media data, which only depends on requirements of the user or media data manager, and is not limited.

The first level of this medium play hierarchical structure is the recorded image of the entire match. The second level is a branch of the recorded image at the first level, and is about team performance behaviors of two parties in the entire match. The third level is a branch of the recorded image at the second level, and is about particular performance behaviors of the two parties in the match, such as a team attack scene and a team defense scene. The fourth level is a branch of the recorded image at the third level, and is about recorded images of close-up scenes of particular players of the two parties in the match.

However, as described above, the scene segment media 31 captured by the medium capturing module 12 are not required to give consideration to the foregoing image level, and the medium capturing module 12 may, according to requirements of the scene instruction 50, capture the scene segment media 31 and the scene segment illustrations 41 corresponding to the same level, different levels or locally the same level and locally different levels from a medium play hierarchical structure, and integrate the scene segment media 31 and the scene segment illustrations 41 into the scene fragment medium 60 and the fragment illustration data 70, so as to transmit the scene fragment medium 60 and the fragment illustration data 70 to the terminal module 20.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A scene fragment transmitting system, comprising:
a serving module, comprising:
a storage module, for storing a piece of media data and a piece of scene description data corresponding thereto; and
a medium capturing module, for, according to comparison between a scene instruction and the scene description data, capturing a scene fragment medium from the media data and outputting the scene fragment medium; and
a terminal module, connected to the serving module, and used for outputting the scene instruction, receiving the scene fragment medium, and presenting a played content of the scene fragment medium.

2. The scene fragment transmitting system according to claim 1, wherein the scene description data records a plurality of pieces of scene play time corresponding to the media data comprising scenes, the scene instruction records at least one required scene play time point, and the medium capturing module matches the at least one required scene play time point and the plurality of pieces of scene play time, so as to capture the scene fragment medium from the media data.

3. The scene fragment transmitting system according to claim 1, wherein the scene description data records a plurality of scene description illustrations corresponding to the media data comprising scenes and play time, the scene instruction comprises at least one piece of required scene data, and the medium capturing module matches the at least one piece of required scene data and the scene description illustrations, and obtains a piece of target play time, so as to capture the scene fragment medium matching the target play time from the media data.

4. The scene fragment transmitting system according to claim 1, wherein the medium capturing module divides the media data and the scene description data into a plurality of scene segment media according to the scene description data, and constructs the scene segment media into a medium play hierarchical structure according to a medium dependence relationship between the scene segment media, image and sound attributes of a medium, and a level relationship formed when media form a hierarchical structure.

5. The scene fragment transmitting system according to claim 4, wherein the medium capturing module captures at least one of the scene segment media with the same level, different levels or locally the same level and locally different levels from the medium play hierarchical structure to form the scene fragment medium.

6. The scene fragment transmitting system according to claim 1, wherein the scene instruction further comprises a medium division mode, each medium division mode comprises types of dividing a time division length and a scene played content of the media data, and the medium capturing module divides the media data according to the medium division mode, and extracts the scene fragment medium corresponding to the scene instruction.

7. The scene fragment transmitting system according to claim 1, wherein the terminal module comprises:
a play module, comprising a play interface for presenting a played content of the scene fragment medium, and playing the scene fragment medium according to a scene play command; and
a control module, used for inputting the scene instruction and the scene play command, wherein the scene play command is used for designating the scene fragment to the play module.

8. The scene fragment transmitting system according to claim 1, wherein the serving module further comprises a bandwidth detecting module, used for detecting available bandwidth of a connection line between the serving module and the terminal module, and the medium capturing module, according to the available bandwidth, determines whether to adjust a capturing mode for the scene fragment medium.

9. The scene fragment transmitting system according to claim 8, wherein the capturing mode is selected from a combination of a group consisting of adjusting a medium capturing frequency of the scene fragment medium, adjusting a medium capturing resolution of the scene fragment medium, adjusting a medium capturing color depth of the scene fragment medium, adjusting a medium capturing gray-scale depth of the scene fragment medium and adjusting a sound capturing frequency of the scene fragment medium.

10. A scene fragment transmitting method, comprising:
outputting, by a terminal module, a scene instruction;
capturing, by a serving module according to comparison between the scene instruction and a piece of scene description data, a scene fragment medium from a piece of media data; and
outputting, by the serving module, the scene fragment medium to the terminal module, so that the terminal module presents a played content of the scene fragment medium.

11. The scene fragment transmitting method according to claim 10, wherein the scene description data comprises a plurality of pieces of scene play time, the scene instruction comprises at least one required scene play time point, and the step of capturing, by a serving module according to comparison between the scene instruction and a piece of scene description data, a scene fragment medium from a piece of media data and the scene description data comprises:
matching, by the serving module, the at least one required scene play time point and the plurality of pieces of scene play time, so as to capture the scene fragment medium from the media data.

12. The scene fragment transmitting method according to claim 10, wherein the scene description data comprises a plurality of scene description illustrations and play time corresponding thereto, the scene instruction comprises at least one piece of required scene data, the step of capturing, by a serving module according to comparison between the scene instruction and a piece of scene description data, a scene fragment medium from a piece of media data and the scene description data comprises:
matching, by the serving module, the at least one piece of required scene data and the scene description illustrations, and obtaining a piece of target play time, so as to capture the scene fragment medium matching the target play time from the media data, and capture fragment illustration data matching the target play time from the scene description data.

13. The scene fragment transmitting method according to claim 10, further comprising:
dividing, by the serving module according to the scene description data, the media data and the scene description data into a plurality of scene segment media; and
constructing, by the serving module, the scene segment media into a medium play hierarchical structure according to a medium dependence relationship between the scene segment media, image and sound attributes of a medium, and a level relationship formed when media form a hierarchical structure.

14. The scene fragment transmitting method according to claim 13, wherein the serving module captures at least one of the scene segment media with the same level, different levels or locally the same level and locally different levels from the medium play hierarchical structure to form the scene fragment medium.

15. A scene fragment play non-transitory recording medium, storing a program code readable by an electronic apparatus, wherein when reading the program code, the electronic apparatus executes a scene fragment transmitting method, and the method comprises the following steps:
outputting, by a terminal module, a scene instruction;
capturing, by a serving module according to comparison between the scene instruction and a piece of scene description data, a scene fragment medium from a piece of media data; and
outputting, by the serving module, the scene fragment medium to the terminal module.

16. The non-transitory recording medium according to claim 15, wherein the scene description data comprises a plurality of pieces of scene play time, the scene instruction comprises at least one required scene play time point, the step, comprised in the method, of capturing, by a serving module according to comparison between the scene instruction and a piece of scene description data, a scene fragment medium from a piece of media data and the scene description data comprises:
matching, by the serving module, the at least one required scene play time point and the plurality of pieces of scene play time, so as to capture the scene fragment medium from the media data.

17. The non-transitory recording medium according to claim 15, wherein the scene description data comprises a plurality of scene description illustrations and play time corresponding thereto, the scene instruction comprises at least one piece of required scene data, the step, comprised in the method, of capturing, by a serving module according to comparison between the scene instruction and a piece of scene description data, a scene fragment medium from a piece of media data comprises:
matching, by the serving module, the at least one piece of required scene data and the scene description illustrations, so as to capture the scene fragment medium from the media data.

18. The non-transitory recording medium according to claim 15, wherein, the method further comprises:
dividing, by the serving module according to the scene description data, the media data and the scene description data into a plurality of scene segment media; and
constructing, by the serving module, the scene segment media into a medium play hierarchical structure according to a Medium dependence relationship between the scene segment media, image and sound attributes of a medium, and a level relationship formed when media form a hierarchical structure.

19. The non-transitory recording medium according to claim 18, wherein the serving module captures at least one of the scene segment media with the same level, different levels or locally the same level and locally different levels from the medium play hierarchical structure to form the scene fragment medium.

20. The scene fragment transmitting system according to claim 1, wherein the scene instruction is not pre-stored and has no corresponding relation with any segments;
wherein the scene instruction is input by a user according with the user's wishes; and
wherein the scene fragment medium are captured and are output to play according to the scene instruction.
